(19) United States
(12) Patent Application Publication
(10) Pub. No.: US 2019/0279284 A1
(43) Pub. Date: Sep. 12, 2019

(54) VIRTUAL REALITY HAPTIC DEVICE

(71) Applicant: Walmart Apollo, LLC, Bentonville, AR (US)

(72) Inventors: Eugene P. Sunday, Glen Ellyn, IL (US); Bruce W. Wilkinson, Rogers, AR (US)

(21) Appl. No.: 16/280,542

(22) Filed: Feb. 20, 2019

Related U.S. Application Data
(60) Provisional application No. 62/640,650, filed on Mar. 9, 2018.

(51) Int. Cl. G06Q 30/06; G06Q 30/02; G02B 27/01; G06F 3/01; G06T 19/00; G06N 20/00; H04N 13/204

(52) U.S. Cl. CPC G06Q 30/0643; G06Q 30/0224; G02B 27/017; H04N 13/204; G06T 19/006; G06N 20/00; G06F 3/016

(57) ABSTRACT

In some embodiments, apparatuses and methods are provided herein useful to collect information regarding haptic characteristics of objects and transmit the same to a haptic feedback device in order to simulate the haptic feedback characteristics of the object. In some embodiments, a sensor device contains movable parts to contact and exert force upon the object in order to measure its firmness, resilience, texture, or other haptic characteristics, and the haptic feedback device contains movable structures to replicate the haptic characteristics for a remote user.

### CROSS-REFERENCE TO RELATED APPLICATIONS

This application claims the benefit of U.S. Provisional Application Number 62/640,650, filed Mar. 9, 2018, which is incorporated herein by reference in its entirety.

### TECHNICAL FIELD

This invention relates generally to virtual reality systems that recreate an object or experience, or an aspect thereof, for a user.

### BACKGROUND

In the retail setting, one area that is becoming of increasing significance is the virtual shopping environment. Some retailers have established an online shopping experience for customers in which the customer may participate in a simulated shopping experience without actually going to a store. Instead, the customer may access the retailer's website and navigate through a realistic appearing store that may have various departments and various types of products for sale. Some shopping experiences also incorporate augmented reality technology, wherein a live direct or indirect view of a real-world environment is augmented or modified by computer-generated perceptual information. In most cases, augmented reality technology adds visual elements to a real-world environment or masks visual elements in order to alter the user's visual perception of a three-dimensional space.

In some virtual reality or augmented reality shopping experiences, head-mounted displays are provided in order to permit the user to change the field of view within a surrounding three-dimensional environment. For instance, new objects may be added to the real-world environment, or the appearance of specific objects within the environment may be altered by overlaying of new or altered images. Additional sensory inputs may be provided to provide user with information about the real-world, augmented, or virtual environment. Haptic gloves are often provided to assist the user in manipulating or interacting with the environment.

However, the immersion of the customer is generally limited in such systems, and does not convey information regarding numerous aspects of products that would be apparent to a user in real life.

### BRIEF DESCRIPTION OF THE DRAWINGS

Disclosed herein are embodiments of systems, apparatuses and methods pertaining to simulating haptic characteristics of objects. This description includes drawings, wherein:

FIG. 1 is a schematic diagram of a system in accordance with some embodiments.

FIG. 2 is a sensor device in accordance with several embodiments.

FIG. 3 is one example of an alternative sensor device for continuously gathering data from a plurality of objects in accordance with some embodiments.

FIG. 4 is one example of a haptic feedback device in accordance with several embodiments.

FIG. 5 is another example of a haptic feedback device in accordance with some embodiments.

FIG. 6 is an example of a haptic feedback device with a configurable shape in accordance with several embodiments.

FIG. 7 is a flow chart demonstrating a method in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Various embodiments, systems, apparatuses and methods are provided herein useful to replicate or represent the sensation of touching an object by providing the user with a physical structure that can act as a virtual object and can be interacted with or manipulated to give a user the impression that a real-world object is being touched or manipulated. In some forms, a haptic device is provided that replicates firmness, texture, and/or resilience of an object across its surface to provide a user with a physical virtual object that replicates a remote object or a portion thereof. In some embodiments, the haptic device has a generally planar surface that adjusts haptic characteristics during use to replicate different areas of a three-dimensional surface. The portion of the object that is replicated may change as the user focuses on or views different portions of the three-dimensional surface. In other embodiments, the haptic device is shaped similarly to the detected object, or a portion thereof, or may be reconfigured to replicate at least a portion of the shape of the detected object. For instance, a spherical or partially spherical haptic device may be provided to mimic detected objects that are generally spherical or rounded, a pyramid-shaped haptic device may be provided to mimic detected objects that are generally pyramidal or tapered, and a rectangular or cube-shaped haptic device may be provided to mimic objects that are generally rectangular or angled. In some embodiments, a system for presenting a user with haptic sensations representative of an object may be provided, the system comprising a sensor device for detecting physical characteristics of an object at multiple areas across at least one surface of the object, a computer memory for receiving and storing the information detected by the sensor device, a haptic feedback device comprising a plurality of movable members that may be adjusted to replicate the physical characteristics of the object as detected by the sensor device, and a control circuit configured to receive information from the sensor device and transmit signals to the haptic feedback device for causing biasing of the movable members in response to the information from the sensor device so that a force exerted by the movable members correlates with the information received by the sensor device in order to replicate the firmness of the object or other detected tactile properties.

In some forms, the system further includes a stereoscopic camera for obtaining images comprising the at least one surface of the object and mapping the images to a three-dimensional coordinate system, and in some embodiments further includes a head mounted display for displaying images from the stereoscopic camera in virtual reality or augmented reality. In some aspects, head-mounted displays may present to the user an artificial environment or an augmented real-world environment (e.g. recorded images of an environment, real-time images of an environment, or a direct view of the environment through transparent portions of the display) with the appearance of specific objects within the environment altered by overlaying of new or altered images. For instance, the head-mounted display may show images of a real-world object superimposed over a haptic feedback device to provide the impression that the user is touching the real-world object when interacting with the haptic feedback device. In some embodiments, the control circuit is configured to cause the head mounted display to present the images from the stereoscopic camera over the haptic feedback device, the images oriented so that portions of the images corresponding to portions of the surface detected by specific portions of the sensor device are aligned with corresponding moveable members from the haptic feedback device. One or more symbols may be placed on the haptic feedback device and an optical sensor associated with the head mounted display may be provided for determining the orientation of the haptic feedback device based on positions of the one or more symbols in order to accurately map the image from the camera to the haptic feedback device within the view provided by the head mounted display. The display may further play recorded sounds (such as audio files recorded during interaction with the object) to enhance simulation of interacting with the virtual object.

In some embodiments, the sensor device is configured for detecting the firmness of an object at multiple areas across at least one surface of an object. In some embodiments the sensor device comprises a support member; a plurality of probes extending from the support member, the probes forming an array of probes and each probe having at least a distal end thereof moveable along a linear path between a proximal position toward the support member and a distal position away from the support member; a drive mechanism for linearly shifting the distal ends of the plurality of probes toward their respective distal positions; at least one regulator for applying a set amount of force from the pneumatic drive mechanism to the plurality of probes; one or more sensors to receive information relating to the amount of movement of the distal ends of the plurality of probes; and a computer memory for receiving and storing the information relating to the amount of movement of the distal ends of the plurality of probes. In some embodiments, the sensor device includes a box structure that may be positioned around an object to be scanned. In some embodiments, a conveyor is provided to deliver a series of objects to the sensor device. In some forms, parts of the sensor device that interact with the object may be driven by pneumatic or hydraulic power. In some forms, the set amount of force applied by the pneumatic drive mechanism that shifts the probes may be adjusted by a user, such as by manually inputting one or more values or information regarding an object to be sensed, or is automatically adjusted based on characteristics of an object to be sensed. For instance, in some forms a user may provide to a control circuit via an input device (such as a keyboard or numerical pad) information regarding characteristics of an object to be sensed, and the control circuit references a database to determine preset force values associated with the information provided by the user and correspondingly adjusts the force applied to the probes.

The sensor device may also include in some embodiments optical sensors, such as laser scanners, color sensors, infrared sensors, and/or ultraviolet sensors, for measuring visual characteristics such as shape, surface contours, color, or other responses to irradiation with specific wavelengths of light. The data from such optical sensors can be compared to and correlated with physical measurements from probes that contact the object, and in cases where a strong correlation between visual characteristics and haptic characteristics exists, the optical sensors may be used to predict texture, firmness, resilience, and other characteristics based on visual cues. For instance, where the sensor device is used to analyze fruit and vegetables, soft areas such as bruises may be recognized based on color. Other sensors may also be employed to assist in predicting haptic characteristics of the object. For instance, ethylene oxide detectors or other chemical sensors may be included in the sensor device to assist in determining how ripe fruit and vegetables are, and the amount of ethylene oxide detected may be used to predict hardness or softness. Machine learning may be employed in some embodiments in order to predict haptic characteristics based on optical scanning or other gathered data by referencing previously-measured correlations between such data and haptic characteristics. In some forms, data from previous operations may be stored in a database for reference during later operations. In some embodiments, machine learning may also be employed to filter data presented to a user or prioritize objects scanned with the sensor device in order to first present users with objects they are most likely to purchase, as determined by past purchases or selections. Machine learning may be of various types, including supervised or unsupervised learning, reinforcement learning, rule-based learning, and clustering.

In some forms, the haptic feedback device may comprise a base member; a flexible membrane coupled to the base member; a plurality of buttress structures arranged in an array of buttress structures corresponding to the array of probes from the sensor device, the array of buttress structures disposed between the base member and flexible membrane, at least a portion of each buttress structure biased toward the membrane, each buttress structure further comprising a solenoid coupled to a power source for modifying a force exerted upon the flexible membrane by the buttress structure.

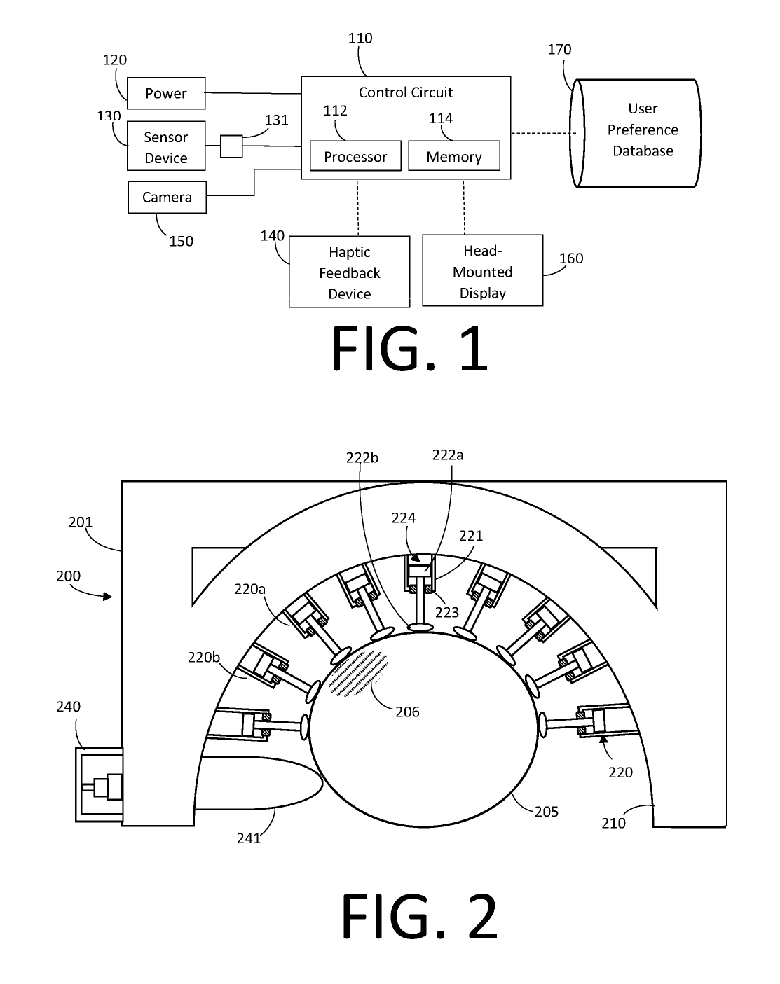

FIG. 1 is a schematic diagram of one virtual reality system 100 for simulating haptic characteristics of a three-dimensional object. The system may, for instance, provide a user with haptic sensations representative of the firmness of an object for wholesale or retail purchase, assisting users in selecting retail items such as produce, furniture, mattresses, and stuffed toys from their homes without the need to travel to a retail location. The system may also be used to assist wholesalers or retailers in sourcing goods remotely without the need to travel to a supplier in order to touch and feel samples of goods. The system 100 includes a control circuit 110 that is coupled to a power source 120 and one or more auxiliary devices, such as a sensor device 130 for detecting haptic characteristics of an object, a haptic feedback device 140 for physically conveying haptic information to a user, a camera 150 for capturing images of objects analyzed by the sensor device 130, and a head mounted display 160 or other device for displaying to a user images from the camera. The system may also include or more databases, such as a user preference database 170, for storing information regarding users, user preferences, and/or objects with which the system interacts. The auxiliary devices may be physically connected to the control circuit 110 or separate, and may communicate in any number of ways, such as via hardwire connections, wireless signals, the internet, or combinations thereof. The system 100 may be configured to have any one or more of the identified auxiliary devices, which may be turned on and off as desired to remove or add functions, and may also include other devices not explicitly discussed herein. The auxiliary devices may have their own power sources, or in some embodiments one or more auxiliary devices may be connected to power source 120 directly or through the control circuit 110.

Generally, the control circuit 110 can include fixed-purpose hard-wired platforms or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein, and can store instructions, code, and the like that is implemented by the control circuit and/or processors to implement intended functionality. In some applications, the control circuit and/or memory may be distributed over a communications network (e.g. LAN, WAN, Internet) providing distributed and/or redundant processing and functionality. In some implementations, the control circuit can comprise a processor 112 and a memory module 114, which may be integrated together, such as in a microcontroller, application specification integrated circuit, field programmable gate array or other such device, or may be separate devices coupled together.

In some embodiments, the control circuit may be locally connected to, or incorporated into, the sensor device 130 and/or haptic feedback device 140, or may be remotely located from both. The control circuit 110 may include one or more cloud-based software components in some embodiments. The power source 120 in communication with the control circuit may be of any conventional type, such as a direct current electrical circuit, an alternating current electrical circuit, a battery, or a solar (photovoltaic) cell. In some embodiments, the control circuit may communicate with auxiliary devices only intermittently and/or as necessary in order to conserve power. The database 170 shown may be contained in the memory module 114 of the control circuit, may exist in a separate computer memory coupled to the control circuit, or may be located on a remote server accessed by the control circuit.

The sensor device 130 is provided for detecting and/or quantifying one or more haptic characteristics of an object, such as shape, firmness, resilience, and texture. In some embodiments, the sensor device 130 includes an array of sensors or structures for analyzing haptic characteristics at multiple areas across at least one surface of the object. The sensor device 130 may comprise, in some embodiments, at least one probe that extend from the support member to be placed in contact with a three dimensional object in order to detect and/or quantify one or more haptic characteristics of the object. In some embodiments, a plurality of probes form an array, each probe having at least a distal end thereof moveable along a linear path between a proximal position toward the support member and a distal position away from the support member. The array of probes may be physically connected to a support member that holds the plurality of probes in a predetermined array.

In some forms, the sensor device contains or is coupled to a drive mechanism 131 controlled by the control circuit 110. The drive mechanism 131 may be of any type capable of physically moving the probes or portions thereof, and in some forms may be pneumatic, hydraulic, electric, or a combination thereof. In some embodiments, the drive mechanism may apply a predetermined amount of force uniformly across an array of probes for linearly shifting the distal ends of the probes toward their respective distal positions. The drive mechanism 131 and/or sensor device 130 may further include at least one regulator for maintaining the force applied from the pneumatic drive mechanism to the plurality of probes at a set amount. The probes may be associated with one or more sensors to receive information relating to the amount of movement of the probes or portions thereof. For instance, optical or magnetic sensors may measure the movement of the probes.

In some embodiments, the probes may be initially gently positioned against an object at a contact position and then driven with a greater amount of force distally to a second pressing position, with the amount of movement between the initial contact position and the pressing position used to determine firmness and/or resilience of the object's surface. In some forms the sensor device may rely on gravity to position the probes into the initial contact position rather than actively moving the probes into initial contact with the object. In some forms, the initial contact position of a plurality of probes is also used to determine the object's shape and/or size. Movement of the probe or probe portions may be determined in any manner, for instance by generation of an electrical current or by movement of physical, optical, magnetic, or other markers relative to sensors. In some embodiments, movement into the initial contact position and subsequent pressing position may be accomplished using the same drive system, such as where two pulses of differing magnitude are provided from a single hydraulic, pneumatic, or electric drive system, or may involve separate drive systems. Placing probes in the initial position may be alternatively accomplished manually. The amount of force exerted upon the probes will vary depending on the information desired by the user and the nature of the object being detected. In some embodiments, for example, the drive system may apply, without limitation, an amount of force in the range of 0.01 psi to 50 psi, or 1 psi to 20 psi, or 2 psi to 15 psi, or 5 to 10 psi.

A stereoscopic camera 150, laser scanner, and/or other optical scanning device may be provided or coupled to the system for obtaining images comprising at least one surface of the object scanned using the sensor device 130. The images may be captured before or after interaction of the sensor device 130 with the object, and in some embodiments the images are captured while the object is in the same orientation in which the object interacts with the sensor device. Optical data may be used to construct a point cloud or other polygon mesh for visualizing the object remotely. In some embodiments, images of the object or portions thereof may be mapped to a three dimensional coordinate system, for instance a point cloud, either by the camera device 150, the control circuit 110, or another device. In some embodiments, optical or laser scanning may be used to determine the overall three-dimensional shape of the object scanned in order to later replicate or reconstruct the same.

The haptic feedback device 140 of the system 100 may comprise a plurality of movable structures controllable by the control circuit 110 in order to represent or imitate haptic characteristics of the object detected by the sensor device 130. In some embodiments, the haptic feedback device 140 comprises a flexible membrane. In some embodiments, the device includes one or more moveable elements, which may be buttress structures that support a flexible membrane. In some embodiments, the haptic feedback device 140 includes a plurality of buttress structures arranged in an array of buttress structures corresponding to the array of probes, and the array of buttress structures may be disposed between a base member to which they are mounted and a flexible membrane that the buttress structures support. In some such embodiments, at least a portion of each buttress structure is biased toward the membrane. The buttress structure may further comprise, for example, a solenoid coupled to a power source for modifying a force exerted upon the flexible membrane by the buttress structure. In some embodiments the haptic feedback device 140 may be shaped generally similarly to the objects detected by the sensor device, for instance generally spherical where the detected objects are apples, oranges, or other round produce. In other embodiments, the haptic device may be relatively flat. If the haptic feedback device includes a flexible membrane or outer covering, the membrane or covering may in some embodiments have a texture representative of the objects detected by the sensor device 130.

The head mounted display 160 may be, for instance, a virtual reality or augmented reality headset or goggle device that displays the images of the object captured by the stereoscopic camera. Alternatively in some embodiments the head mounted display may show the user stock images generally representative of an object instead of captured images of a specific object. In some embodiments, the images are mapped over the haptic feedback device 140 so that it appears to the user that they are manipulating the object. The images may be oriented relative to the haptic feedback device 140 in the head mounted display by reference to visual indicators on the haptic device's surface, such as symbols, letters, numbers, QR codes, shapes, or other visual elements, or by other methods (such as radiofrequency markers embedded in the haptic device. In some forms, the control circuit 110 is configured to transmit images (for instance images from the stereoscopic camera 150) to the head mounted display 160 and cause the head mounted display to present the images overlaying or superimposed over the haptic device and oriented so that portions of the images corresponding to portions of the surface detected by specific probes of an array are aligned with corresponding buttress structures of the haptic feedback device 140.

FIG. 2 is a cross-section of one example of a sensor device 200 in accordance with some embodiments for detecting haptic characteristics of an object 201. The sensor device 200 is configured to surround at least a portion of an object 205 (for instance, a unit of produce) to be detected, and in this example, forms a box-like structure with a generally concave inner surface 210. The generally concave inner surface 210 is well adapted for surrounding generally spherical objects, although other configurations are also contemplated. In some embodiments, a duplicate sensor device may be placed under the object in order to fully surround the object 205. Extending from the inner surface 210 are a plurality of probes 220 forming an array that surrounds the object 205 to be detected. In various embodiments the probes may be spaced apart by about 1 mm to about 1 cm for objects several centimeters or inches across, or greater, such as about 1 cm to 10 cm, 25 cm, or 50 cm apart, for larger objects. The probes alternatively may be placed closer together or further apart as desired depending on the size and nature of objects to be detected, and in some embodiments only one or a small number of probes could be used to measure representative samples of haptic characteristics in order to estimate haptic characteristics of areas that are not contacted by probes. Each probe includes an outer casing 221 and a movable portion 222, in this case a piston, that is slidable within the casing 221. The movable portion 222 has an enlarged proximal end 222a and a blunt distal end 222b, with a narrower neck portion therebetween that passes through a seal 223. The casing 221 includes a chamber 224 rearward of the movable portion proximal end 222a that may be filled with a fluid or gas by an associated drive mechanism to drive the movable portion 222 linearly in a distal direction toward the object 205. The distal end 222b is in this embodiment blunted in order to minimize the possibility of puncturing or damaging the detected object 205.

A first amount of force may be applied to the movable portions 222 of the probes 220, preferably simultaneously, so that the distal ends 222b contact the object 205. At this point, the positions of the various movable portions 222 relative to the casings 221 of the probe array may be recorded to determine the general shape of at least a portion of the object 205. Alternatively, the probes 220 may slide into position and be brought into contact with the object 205 solely by gravity in some embodiments. A second amount of force, greater than the first amount of force, may then be applied to the movable portions 222, preferably simultaneously, and the amount of movement of each individual movable portion 222 in the distal direction is recorded to determine the firmness of various regions of the object 205. In the instance depicted, a bruised or soft area 206 leads to greater movement of the adjacent probe 220a than in other probes of the array. Movement of the movable portions 222 in the proximal direction when the pressure applied to the probes by the drive mechanism ceases may be recorded and used to represent resilience of the object 205. In many cases movement of probes will be relatively small, and therefore sensors detecting movement of the probes in many embodiments should be capable of measuring linear movement of 1 mm or less.

The sound made by impacting the object 205, such as the “thunk” sound generated by tapping or flicking produce with one's finger, may be imitated by applying a third amount of force to one or more of the probes or, alternatively, a separate impact member 240. The impact member 240 may be configured to linearly shift to drive a blunt end 241 into contact with the object 205, or alternatively may be configured to be pivotable and swing into contact with the object 205 in order to better imitate the flicking motion of a human finger. The impact member 240 may be driven by a spring, a pneumatic, hydraulic, or electric drive system, or other means. An audio recording device may be provided for recording sounds generated by contact between the impact member and the object, and for storing the recorded sounds as an audio file. In some embodiments the recording device is located on the impact member or an interior surface of the sensor device for capturing sounds near the point of impact. In alternative embodiments, the recording device may be located at a distance from the impact member to replicate the distance of a user's ear from the object as the object is tapped or flicked with a finger. The audio file recorded during impact of the object may be linked to the identity of the object or other information relating to the object that is stored in a database. A speaker associated with a head mounted display may be provided in some embodiments in order to play the audio file when the user requests sounds relating to the object, and in some embodiments the user requests sounds by making gestures normally associated with generating those sounds, such as tapping or flicking motions.

FIG. 3 illustrates an alternative sensor system 300 for continuously receiving and gathering information regarding haptic characteristics of objects. In the depicted system, a pair of rollers 301 and 302 are each equipped with external probes, 321 and 322 respectively. Alternatively, a single roller may be provided. The probes 321 and 322 form arrays that contact opposed sides of an object 305 passing between the rollers 301 and 302. A first conveyor 303 transports the object 305 to the rollers and a second conveyor 304 transports the object 305 away from the rollers. The plurality of probes 321 and 322 operate in a manner similar to probes 220 described in connection with FIG. 2, and may be driven outward by pneumatic, hydraulic, electrical, mechanical, or other forces so that movement of at least a portion of the probes may be used to assess haptic characteristics of the object 305. In this embodiment, a continuous stream of objects may be detected and analyzed, reducing the time required to map the objects. The rollers are configured and positioned so that objects pass with minimal compression to the objects other than force exerted by the plurality of probes. In some embodiments, rollers are configured to rotate the item in order to more effectively scan the entire surface of some objects. For example, the object may pass through opposed rollers as shown in FIG. 3, with the rollers rotating at slightly different speeds in order to rotate the object as it passes between the rollers.

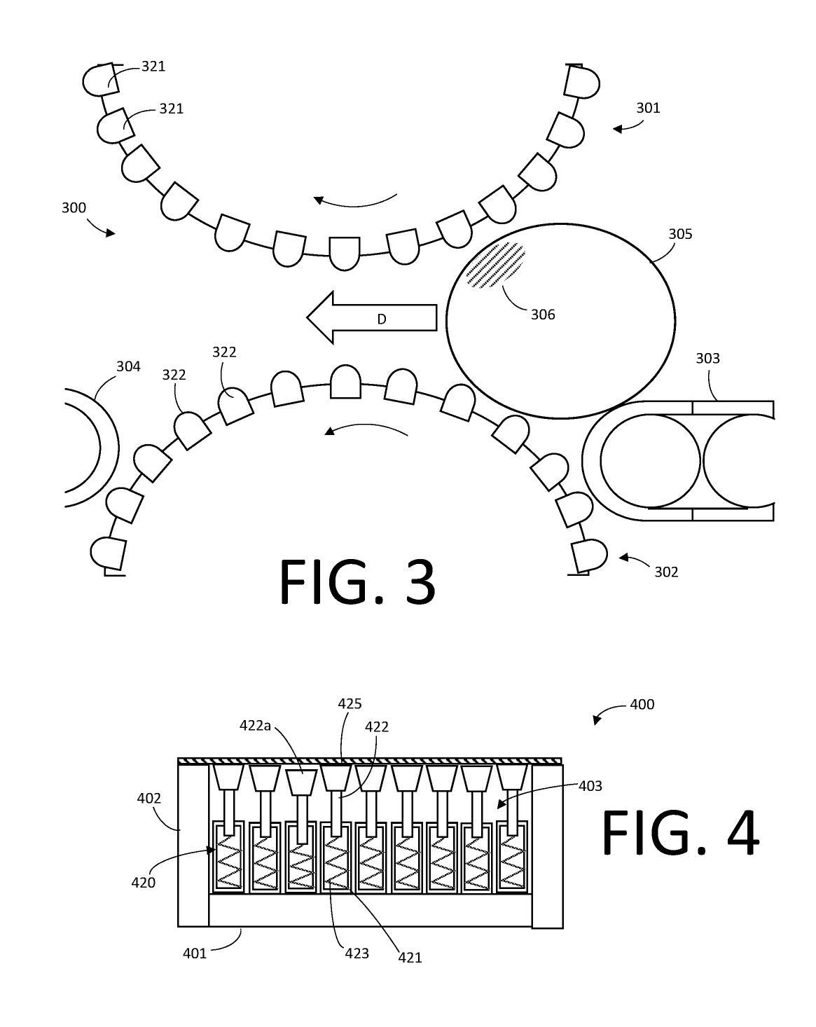

A cross-sectional view of one example of a haptic feedback device 400 is illustrated in FIG. 4. The haptic feedback device 400 in this example includes a base member 401 and upstanding sidewalls 402 to form an interior space 403 in which a plurality of buttress members 420 are housed. The buttress members 420 support a flexible membrane 430 tensioned between the sidewalls 402. The membrane 430 may in some embodiments be a semi-hard rubber, and in some embodiments, may be made of polyurethane. In some embodiments, the membrane 430 may be a flexible liquid crystal display that displays images of portions of an object simulated, or that provides texture feedback via first and second conducting layers of patterned individually-activated electrodes separated by an insulating layer as discussed further herein. LCD touchscreens in some embodiments may send precise electrical impulses to a user's fingertips in order to simulate a wide variety of textures, providing a more immersive experience to the user and providing an additional level of haptic feedback regarding the object's surface characteristics. A control circuit in communication with the haptic feedback device 400 is configured to receive information regarding each of the regions of an object to be simulated (for instance information gathered by a sensor device as shown in FIG. 2) and then transmit control signals to buttress structures (e.g. the plurality of buttress members or structures 420) to cause each buttress structure to exert a force on the flexible membrane representative of the firmness, softness, or texture of the corresponding region of the object.

The buttress members 420 of FIG. 4 each include a slidable piston 422 that shifts relative to an outer casing 421 in response to signals received from a control circuit. While the upper membrane 430 of this embodiment remains relatively flat at all times, movement of the buttress member pistons 422 may be used to vary the firmness and/or resilience of individual regions of the membrane 430. Alternatively, the device may not contain a membrane, so that a user's hand contacts the buttress members directly. The pistons 422 may include enlarged heads 425 to distribute force applied to the membrane 430. The buttress members may be driven toward the membrane 430 by a drive mechanism, such as a pneumatic, hydraulic, mechanical, or electrical drive mechanism, or may be biased toward the membrane 430 and retracted by a drive mechanism. In the illustrated embodiment, the pistons 422 of the buttress members shift linearly relative to their casings 421 when a current is applied to a solenoid 423 within each buttress member. The current applied to each buttress member 420 may be varied as needed by the control circuit in order to replicate haptic characteristics of a detected object. For instance, piston 422a is less forcefully biased toward the membrane 430 relative to the other pistons in the array of buttress members to provide a soft spot on the membrane corresponding to the bruise 206 on the object 205 scanned in FIG. 2. The force applied to the pistons 422 of the various buttress members 420 may vary during use to replicate different surfaces of the object 205. For instance, as a user rotates a three dimensional image of the object, portions of the object may be mapped to the membrane surface of the haptic feedback device 400, and as a new surface of the object image faces the user the force applied to the buttress member pistons 422 will change to reflect haptic data from that surface of the object gathered from the sensor device.

The membrane 430 of the haptic feedback device may be textured in order to more accurately reflect the surface of the types of objects scanned. For instance, if produce such as apples, bananas, or watermelon are being scanned by the system, the membrane 430 may be provided with a smooth waxy coating. A slightly bumpy or roughened surface may be provided to replicate oranges, grapefruit, and the like. A cloth covering may be provided if furniture, pillows, or similar items are simulated. In some embodiments, a plurality of interchangeable membranes or a membrane with differing texture regions may be provided, and in some embodiments may be relocated or interchanged automatically by the haptic feedback device according to incoming signals relating to haptic characteristics of a detected object. For instance, several membranes may be stored in a sleeve connected to the feedback device, so that a membrane best approximating the object surface may be slid from the sleeve over the surface of the feedback device. The membrane also may include heating and/or cooling elements in some embodiments to replicate the warmth or coolness of objects, with the temperature of the membrane adjusted by a control circuit based on values from a database associated with the type of item simulated or based on actual temperature measurements taken from the sensed object.

The membrane may also incorporate vibratable components to alter the haptic sensations provided, or incorporate electrodes to provide electromagnetic pulses or electrostatic fields capable of replicating a variety of surface textures. For instance, electrostatic haptic feedback touchscreen technology from Senseg OY (Espoo, Finland) or electromagnetic touchscreen technology from Tanvas Corp. (Chicago, Ill.) to create variable haptic surface effects at the surface of the membrane 430. These touchscreens provide impulses to a user's fingertips to provide sensations that simulate subtle surface textures. In particular, surfaces as described in US Published Patent Application Numbers 2014/0375580, 2016/0124548, 2016/0349880, 2016/0357342, and 2017/0168572, all of which are hereby incorporated by reference in their entirety, discloses electrostatic haptics in which frictional force along the surface is modulated via an electrical field at the point of contact between the fingertip and the touch surface by placing one or more electrodes on the touch surface of the substrate and insulating those electrodes from the user's fingertip with a dielectric layer. A circuit through the user's finger creates an electrical field, and the circuit may be closed through a second contact at some other part of the body (e.g. a second fingertip) or by two separate electrodes placed under a single contact location to close the circuit through only a single fingertip. In some embodiments, the dielectric layer is about 0.1-50 microns thick, allowing a relatively large electric field to be produced without extremely high voltages. Arrays of electrode pairs on the touch screen surface permit the electric field to be varied from electrode pair to electrode pair, providing a sensation of varying friction across the screen surface that can be patterned to simulate roughened or smooth surfaces, or a combination thereof. For instance, in some embodiments pairs of electrodes may be positioned in a lattice. By appropriately patterning and stimulating the electrodes, the screen may be configured to mimic cloth, wood, stone, plastic, or various features of organic matter (such as bumps, microabrasions, or surface roughness of fruits and vegetables). In some embodiments, the sensations transmitted to the user may change as the user examines another portion of the object or zooms in on the object. In some embodiments, the screen may be used to examine the texture of only a portion of the object at any given time.

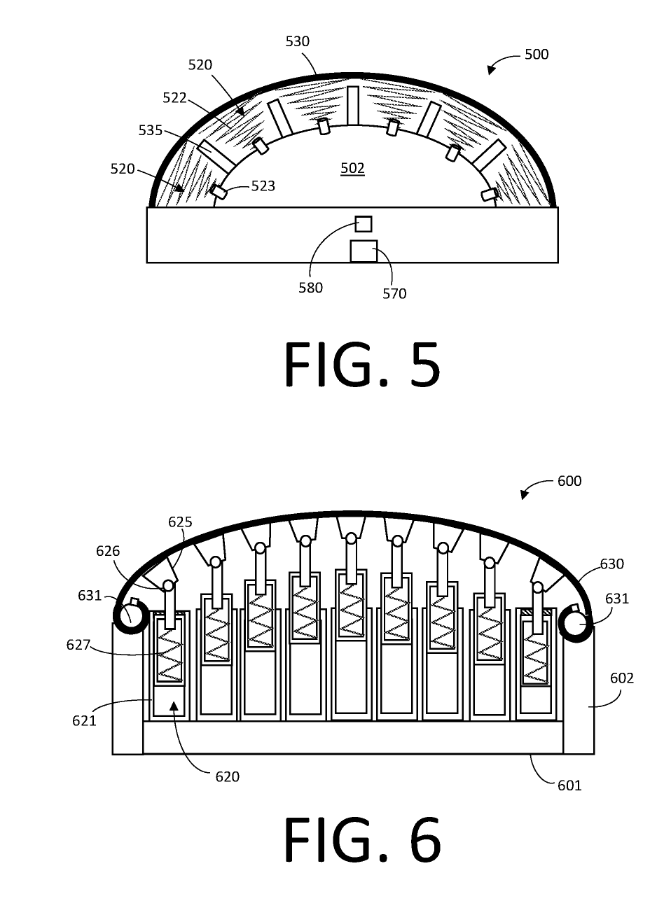

FIG. 5 illustrates a cross-section of an alternative haptic feedback device 500. In various forms, haptic feedback devices may be shaped to generally represent the type of object that is simulated. For instance, in some embodiments a sensor device as shown in FIG. 2 is adapted for sensing rounded objects and may be paired with a curved or hemi-spherical haptic feedback device 500. While the hemispherical shape of this example haptic device is advantageous in that its flat base 501 allows it to rest on a desk or table while a user interacts with the upper surface, the device may alternatively be formed as a full sphere that can be easily held in the hand of a user and manipulated in a fashion more like a spherical simulated object. The device is similar to the haptic feedback device in that it includes a membrane 530 that may be tensioned between areas mounted to the base 501 and a plurality of buttress structures 520 arranged in an array. The membrane may comprise an LCD touchscreen that provides impulses to a user's fingertips to provide sensations that simulate subtle surface textures, as discussed in more detail above in connection with FIG. 4. In the example shown in FIG. 5, the buttress members 520 comprise conical springs 522 each coupled to a solenoid 523. However, in alternative embodiments the buttress members may be pistons as in FIG. 4 or other structures capable of exerting variable force in an outward direction. The buttress members 520 are arranged in a hemi-spherical array. A receiver 570 receives signals relating to an object to be simulated and transmits the signals to a controller 580 that varies the electrical current provided to each of the solenoids 523 as needed to vary the force exerted by the associated conical springs 522 on adjacent portions of the membrane 530. The buttress members 520 may be separated by one another by partitions 535 in order to maintain a desired alignment. As with the embodiment of a haptic device shown in FIG. 4, the membrane 430 of the haptic feedback device may be textured in order to more accurately reflect the surface of the types of objects scanned, or may include electrodes or other components for varying haptic sensations as a user's fingertips contact the membrane 530. The membrane 530 also may include heating and/or cooling elements to replicate the warmth or coolness of simulated objects

In some embodiments, the haptic feedback device may be configured to vary both the shape and the firmness/resilience of a membrane in order to simulate a wide variety of different objects. FIG. 6 shows a cross-section of one such haptic feedback device, where the buttress structures 620 each comprise a fixed outer casing 621 and a movable piston 622, the pistons 622 movable relative to their respective casings 621 in order to alter the topography of the membrane 630 that the buttress structures support. A base 601 supports the plurality of buttress members, and vertical walls 602 enclose the buttress members and support the edges of the membrane 630. The pistons 622 may be adjusted through a drive system as needed during use to simulate a variety of shapes. In the configuration shown by example in FIG. 6 the pistons 622 are arranged to simulate a convex outer surface of a simulated object, but the relative heights of the various pistons 622 also may be shifted to simulate generally concave, flat, pyramidal, or other shapes of surfaces. As the membrane shape changes, tensioning devices 631 at each wall may be provided to increase or decrease the tension of the membrane as needed. The tensioning devices 631 may be, for instance, pins that may be rotated in opposed directions to tighten or loosen the membrane 630 in order to provide more or less membrane between the walls 602 of the device. The pistons 622 also include a head portion 625 to distribute forces across an area of the membrane 630, and in the example shown is pivotable relative to the piston 622 via a flexible joint 626. The firmness of various areas across the membrane 630 may be varied by adjusting a spring 627 supporting the head portion 625 to alter the force with which the head portion 625 is braced against the membrane 630 in a manner similar to that described in earlier embodiments.

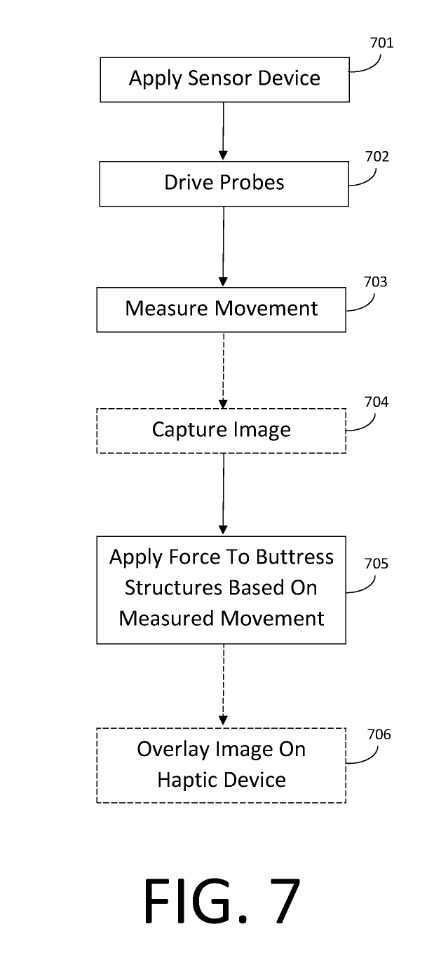

As shown in FIG. 7, a method of using a haptic feedback device to simulate interacting with a remote object may in some embodiments involve several steps. For instance, a haptic feedback device may be used to simulate the firmness of an object for wholesale or retail purchase in a virtual reality system in a method that includes a step of applying a sensor device to an object (Step 701), the sensor device in some embodiments comprising a plurality of probes arranged in an array, with each of the probes positioned against a surface of the object under application of a first amount of force. In some embodiments gravity moves the probes into contact with the object, while in others a pneumatic or hydraulic force is applied to the probes to shift them toward the object. The probes are then driven toward the surface of the object under application of a second amount of force greater than the first amount of force (Step 702). The amount of movement of each probe between application of the first amount of force and second amount of force is measured, for instance via optical sensors that detect symbols, codes, physical structures, or other indicators along the length of the shifting probe (Step 703). A signal representative of the movement of each probe is then transmitted to a control circuit. An image, in some embodiments a three-dimensional image, of at least the measured surface of the object also may be optionally captured using a stereoscopic camera (Step 704).

A control circuit receives information regarding haptic characteristics of the object based on signals from the sensor device relating to the amount of movement of the probes, and then the control circuit transmits one or more control signals to a haptic feedback device sufficient to cause a plurality of buttress structures to exert an amount of pressure on a flexible membrane (Step 705). The buttress structures may be arranged in an array with each buttress structure corresponding to a different one of the probes of the sensor device so that the pressure exerted on the flexible membrane in a given region corresponds to the firmness of a corresponding region of the object. Optionally, if images of the object have been captured, the control circuit may also transmit the three-dimensional image from the stereoscopic camera to a head mounted display so that the three-dimensional image is mapped to the haptic device. The regions of the three-dimensional image corresponding to portions of the object sensed by specific probes are overlayed on the haptic device at buttress members simulating a firmness level of the corresponding probe.

In some embodiments, an apparatus and a corresponding method performed by the apparatus, comprises a virtual reality system for presenting a user with haptic sensations representative of the firmness of an object for wholesale or retail purchase, the system having (i) a sensor device for detecting the firmness of an object at multiple areas across at least one surface of the object, the sensor device comprising a support member, a plurality of probes extending from the support member, the probes forming an array of probes and each probe having at least a distal end thereof moveable along a linear path between a proximal position toward the support member and a distal position away from the support member, a pneumatic or hydraulic drive mechanism for linearly shifting the distal ends of the plurality of probes toward their respective distal positions, at least one regulator for applying a set amount of force from the drive mechanism to the plurality of probes, one or more sensors to receive information relating to the amount of movement of the distal ends of the plurality of probes, and a computer memory for receiving and storing the information relating to the amount of movement of the distal ends of the plurality of probes; (ii) a stereoscopic camera for obtaining images comprising the at least one surface of the object and mapping the images to a three dimensional coordinate system; (iii) a haptic feedback device comprising a base member, a flexible membrane coupled to the base member, a plurality of buttress structures arranged in an array of buttress structures corresponding to the array of probes, the array of buttress structures disposed between the base member and flexible membrane, at least a portion of each buttress structure biased toward the membrane, each buttress structure further comprising a solenoid coupled to a power source for modifying a force exerted upon the flexible membrane by the buttress structure; (iv) a head mounted display for displaying the images from the stereoscopic camera mapped to the haptic feedback device; and (v) a control circuit configured to receive from the sensor device the information relating to the amount of movement of the distal ends of the plurality of probes, transmit signals to the haptic feedback device for causing the solenoids of the plurality of buttress structures to shift at least a portion of the buttress structures in response to the information relating to the amount of movement of distal ends of corresponding probes so that the force exerted upon the membrane by each buttress member is correlated with the information relating to the amount of movement of the distal end of a corresponding probe of the sensing device so that the firmness of the flexible membrane as supported by the buttress structures is representative of the firmness of the object, and cause the head mounted display to present the images from the stereoscopic camera over the haptic device and oriented so that portions of the images corresponding to portions of the surface detected by specific probes of the array of probes are aligned with corresponding buttress structures from the array of buttress structures.

In some forms, the user of a haptic feedback device may purchase the object being simulated, or another representative object, for instance my manipulating the haptic feedback device in a defined manner, by providing input via a separate device (e.g. mouse or keyboard), or by issuing voice commands that are detected by a microphone and transmitted to the control circuit. In one example, the user may touch the haptic feedback device to determine its firmness, and then shake or move the haptic feedback device in a predetermined manner in order to initiate a purchase. In some forms, the system may track the user's purchases and determine correlations between information and characteristics regarding purchased items.

In some embodiments, a plurality of objects are measured as in steps 701 through 704 and information regarding each object is maintained in a database for later use. A user, who may or may not have been involved in the measuring process, may then be presented with the option of selecting one of the previously measured objects, whereupon the information from the database will cause application of forces to buttress structures of a haptic feedback device as in step 705 in order to simulate the particular selected object. In some forms, the apparatus and/or method may employ machine learning in order to narrow the options presented to the user, prioritize the options, and/or make suggestions to the user based on previous selections by the user. For instance, if the system is used to simulate fruits or vegetables, in some embodiments the system will allow the user to rate the fruits and vegetables or provide other input regarding the desirability of certain characteristics. The system may then use this input to select the fruits and vegetables most likely to be purchased by that particular user during subsequent operations. In some embodiments, unsupervised learning may be used to select one or more items for presentation to the user based on past input or correlations between characteristics of purchased items. Information regarding preferences or past purchases may also be used to offer the user incentives.

The system may in some embodiments also allow the user to import preferences of other users. For instance, family members may share preferences in various items, especially food items, due to shared experiences and culture. In some embodiments individual users may have individual user accounts that track individual preferences, purchases, and/or other personal information. Users may link their account to that of another user in order to receive information about the other user's preferences, and may import the other user's preferences and/or purchase history information in whole or in part. In this way, families or other groups may link to one another's preferences to allow machine learning to benefit from a larger data set and make suggestions, prioritize items, and offer incentives based on family member input and/or purchases.

In some embodiments, machine learning may also be used to establish correlations between visual characteristics of items and texture, firmness, resilience, and/or other haptic characteristics, in order to reduce the need to apply a physical sensor device to the objects or to reduce the time needed to use the sensor device. For instance, supervised learning may be employed wherein when the sensor device is used on a piece of fruit in steps 701-703, optical sensors also measure visual characteristics of the fruit and pair them with haptic measurements in a database. During future operations on the same type of fruit, the system uses data from prior operations to predict haptic characteristics based on detected visual characteristics, and compares the prediction to actual measurements of the haptic device.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A virtual reality system for presenting a user with haptic sensations representative of the firmness of an object for wholesale or retail purchase, the system comprising:
a sensor device for detecting the firmness of an object at multiple areas across at least one surface of the object, the sensor device comprising:
a support member;
a plurality of probes extending from the support member, the probes forming an array of probes and each probe having at least a distal end thereof moveable along a linear path between a proximal position toward the support member and a distal position away from the support member;
a pneumatic drive mechanism for linearly shifting the distal ends of the plurality of probes toward their respective distal positions;
at least one regulator for applying a set amount of force from the pneumatic drive mechanism to the plurality of probes;
one or more sensors to receive information relating to the amount of movement of the distal ends of the plurality of probes; and
a computer memory for receiving and storing the information relating to the amount of movement of the distal ends of the plurality of probes;
a stereoscopic camera for obtaining images comprising the at least one surface of the object and mapping the images to a three dimensional coordinate system;
a haptic feedback device comprising:
a base member;
a flexible membrane coupled to the base member;
a plurality of buttress structures arranged in an array of buttress structures corresponding to the array of probes, the array of buttress structures disposed between the base member and flexible membrane, at least a portion of each buttress structure biased toward the membrane, each buttress structure further comprising a solenoid coupled to a power source for modifying a force exerted upon the flexible membrane by the buttress structure;
a head mounted display for displaying the images from the stereoscopic camera mapped to the haptic feedback device; and
a control circuit configured to:
receive from the sensor device the information relating to the amount of movement of the distal ends of the plurality of probes;
transmit signals to the haptic feedback device for causing the solenoids of the plurality of buttress structures to shift at least a portion of the buttress structures in response to the information relating to the amount of movement of distal ends of corresponding probes so that the force exerted upon the membrane by each buttress member is correlated with the information relating to the amount of movement of the distal end of a corresponding probe of the sensing device so that the firmness of the flexible membrane as supported by the buttress structures is representative of the firmness of the object; and
cause the head mounted display to present the images from the stereoscopic camera over the haptic device and oriented so that portions of the images corresponding to portions of the surface detected by specific probes of the array of probes are aligned with corresponding buttress structures from the array of buttress structures.

2. The system of claim 1, wherein the flexible membrane comprises polyurethane.

3. The system of claim 1, wherein the flexible membrane of the haptic feedback device has a generally curved surface.

4. The system of claim 3, further comprising one or more symbols on the haptic feedback device and an optical sensor associated with the head mounted display for determining the orientation of the haptic feedback device based on positions of the one or more symbols.

5. The system of claim 1, wherein the haptic feedback device is generally spherical and the buttress structures comprise conical springs.

6. The system of claim 1, wherein the array of probes is disposed at one end of a box structure sized and configured to be placed around the object.

7. The system of claim 1, wherein the array of probes is associated with a conveyor device for conveying the object from a first position to a second position.

8. The system of claim 1, wherein the control circuit transmits information relating to a price discount via the display device based on information relating to prior use of the system.

9. The system of claim 1, wherein each probe in the array is spaced apart from adjacent probes by a distance between 1 mm to 1 cm.

10. The system of claim 1, further comprising a moveable impact member for impacting the object, an audio recording device for recording sounds generated by impact of the impact member with the object and storing the recorded sounds as an audio file, and a speaker associated with the head mounted display for playing the audio file.

11. A haptic feedback device for simulating the firmness of an object, the haptic feedback device comprising:
a base member;
a flexible membrane coupled to the base member;
a plurality of buttress structures arranged in an array between the base member and the flexible membrane, each buttress structure of the array corresponding to a region of the object to be simulated; and
a control circuit coupled to the array;
wherein the control circuit is configured to receive information regarding each of the regions of the object and transmit control signals to the buttress structures to cause each buttress structure to exert a force on the flexible membrane representative of the firmness of the corresponding region of the object.

12. The haptic feedback device of claim 11, wherein the flexible membrane comprises first and second conducting layers of patterned individually-activated electrodes separated by an insulating layer.

13. The haptic feedback device of claim 11, wherein the flexible membrane has a generally curved surface.

14. The haptic feedback device of claim 11, wherein the buttress structures comprise springs.

15. The haptic feedback device of claim 11, wherein the buttress structures comprise pneumatic pistons.

16. A method of simulating the firmness of an object for wholesale or retail purchase in a virtual reality system, the method comprising:
applying a sensor device comprising a plurality of probes arranged in an array to the object and positioning each of the probes against a surface of the object under application of a first amount of force;
driving the probes toward the surface of the object under application of a second amount of force greater than the first amount of force;
measuring an amount of movement of each probe between application of the first amount of force and second amount of force;
transmitting a signal representative of the movement to a control circuit for each probe;
capturing a three-dimensional image of at least the surface of the object using a stereoscopic camera;
transmitting one or more control signals from the control circuit to a haptic feedback device sufficient to cause a plurality of buttress structures to exert an amount of pressure on a flexible membrane, the buttress structures arranged in an array with each buttress structure corresponding to a different one of the probes of the sensor device so that the pressure exerted on the flexible membrane in a given region corresponds to the firmness of a corresponding region of the object; and
transmitting to a head mounted display the three-dimensional image from the stereoscopic camera so that the three-dimensional image is mapped to the haptic device with regions of the three-dimensional image mapped to corresponding buttress members each simulating a firmness level of the respective mapped region.

17. The method of claim 16, wherein information regarding multiple objects is presented to a user to allow the user to select which object will be simulated on the haptic feedback device and the head-mounted display.

18. The method of claim 17, wherein machine learning is implemented to determine at least in part the information that is presented to the user.

19. The method of claim 18, wherein the machine learning utilizes information relating to past purchases.

20. The method of claim 18, wherein the machine learning utilizes information relating to the purchases of family members of a user wearing the head-mounted display.
